(19) United States
(12) Patent Application Publication
(10) Pub. No.: US 2012/0240463 A1
(43) Pub. Date: Sep. 27, 2012

(54) MODULAR PLANTING AND CULTIVATING CONTAINER AND SYSTEM AND REVEGETATION METHOD USING SUCH CONTAINERS

(75) Inventors: Pierre-Etienne Bindschedler, Obernai (FR); François Lassalle, Strasbourg (FR); Lionel Sindt, Illkirch (FR); Yannik Beix, Saclay Le Val D'Albian (FR)

(73) Assignee: SOPREMA, STRASBOURG (FR)

(21) Appl. No.: 13/505,048

(22) PCT Filed: Oct. 29, 2010
(86) PCT No.: PCT/FR2010/052325

§ 371 Date: Jun. 11, 2012

(30) Foreign Application Priority Data
Oct. 29, 2009 (FR) 0957631

(51) Int. Cl. A01G 9/02; A01G 1/00

(52) U.S. Cl. 47/65.7; 47/66.1; 47/66.7; 47/65.9

(57) ABSTRACT

A modular planting and cultivating container and a revegetation method using such containers. The planting and cultivating container is essentially made up of a rectangular tray having a flat or ribbed bottom and side walls, as well as a body forming a rectangular sleeve removably mounted on and/or in the tray and extending, when mounted, past the upper edges of the side walls of the tray, the container (1) being characterized in that the tray (2) and the sleeve (5) are made from a hollow planar material made up of at least two sheets connected via a bridging structure.

This invention relates to the field of creating surfaces on which plants are placed, more particularly the installation of extensive or semi-intensive vegetation on surfaces that are high and generally inaccessible, such as the surfaces of roofs, roof terraces, or the like.

The object of the invention is more particularly a modular container for the above-mentioned embodiments, a system for placing plants that comprises such modules, and a process for producing extensive vegetation that uses said modules.

For several decades, there has been a demand as regards the management of roofs, in particular flat ones but also sloped ones, and terraces, for the installation of vegetation on these substrates.

These “roof-garden”-type embodiments, which are known in particular under the name “terrace gardens” or intensive plant-placing, are generally created by the garden entrepreneur who places a drainage layer on the substrate, covers it with loam, and thereon cultivates ornamental plants of the same type as in gardens on the ground.

To avoid excessive weight and the problems of maintenance resulting from this traditional technique, alternate techniques have been proposed that do not require spraying and using selected components (substrates, filtering layer and drainage layer) on a small thickness and for a specific range of plant varieties, optionally, at least partially, packaged in the form of rolls to be unrolled on site.

Nevertheless, these alternate techniques come only in the form of standard systems that are suitable for large surfaces, are intended to be used by specialists, are not accessible to the occasional do-it-yourself user, are not suitable for small surfaces, and can be adapted only with difficulty to the particular constraints such as local climatic constraints, specific aesthetic constraints, etc.

In addition, these alternate techniques require the systematic installation of a filtering layer between the plant substrate and the drainage layer as well as the installation of stop elements on the sloped substrates for retaining different layers.

To attempt to overcome these drawbacks, it was proposed to implement modular systems for placing plants based on pre-planted containers, adapted to surfaces of variable size and able to be placed on an airtight substrate, without requiring professional management.

Such a solution is, for example, proposed by the filing FR 2 793 383 in the name of the applicant, whose modules in the form of pre-planted planters can be placed on an airtight substrate by means of a draining intermediate layer.

However, it was noted that, under certain circumstances, the junction lines between modules remained visible and imparted to the unit where plants were placed an appearance of a checkerboard structure, accentuated by the relatively small thickness of the plant substrate.

Similar solutions, using airtight planters or containing plant substrate, were presented in the documents FR 2 929 632 and EP 1 044 599, these latter variants exhibiting the same limitation as the one derived from the above-mentioned filing FR 2 793 393.

So as to overcome this limitation, it was proposed, as the document US 2008/018710 shows, for example, to make the container in two separable parts, namely a lower planter and a body in the shape of a sleeve or collar that is mounted on said planter and extends its walls upward.

In the different embodiments of the container that is disclosed by this document, the body in the shape of a collar or slatted side consists of a simple strip or flexible sheet and requires firm lateral support, obtained by means of multiple locking or hooking means that are integrated in the planter or the provision of side walls of the planter of great height. The result again is a checkerboard appearance for the surface on which plants are placed and a large consumption of material for the creation of the planter.

Thus, this removable body in the shape of a collar or slatted side has a side wall that is too flexible for, on the one hand, effectively retaining a plant substrate layer that in particular projects beyond the side walls of the planter, and, on the other hand, for allowing, if necessary, a binding of pre-planted containers.

In addition, the container that is targeted by the above-mentioned US document has a complex shape to be manufactured, leading to a high cost.

This invention has as its object to overcome at least some of the drawbacks attached to the solution that is the object of this US document, in particular those linked to the collar-shaped body.

For this purpose, the invention has as its object a modular container for planting and cultivation, essentially consisting of a smaller container in the shape of a rectangular planter with a flat or ribbed bottom and side walls and a body in the shape of a rectangular sleeve that is mounted in a removable manner on and/or in said planter and extending, in the mounted state, beyond the upper edges of the side walls of the planter, a container that is characterized in that at least the sleeve is made of a hollow flat material that consists of at least two sheets that are connected by a bridging structure.

The invention will be better understood using the description below, which relates to a preferred embodiment, provided by way of nonlimiting example and explained with reference to the accompanying diagrammatic drawings, in which:

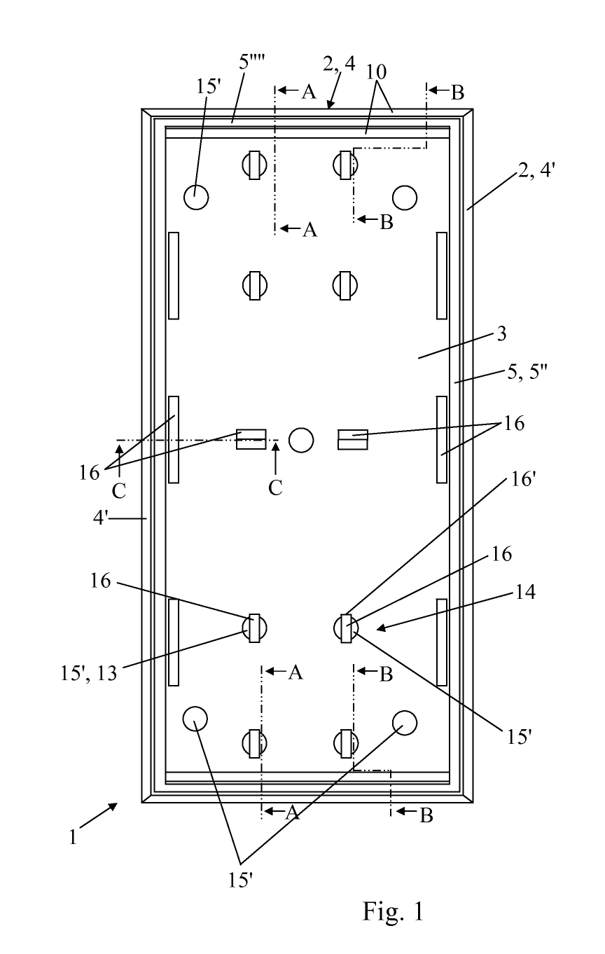

FIG. 1 is a diagrammatic top view of a container according to a first embodiment of the invention;

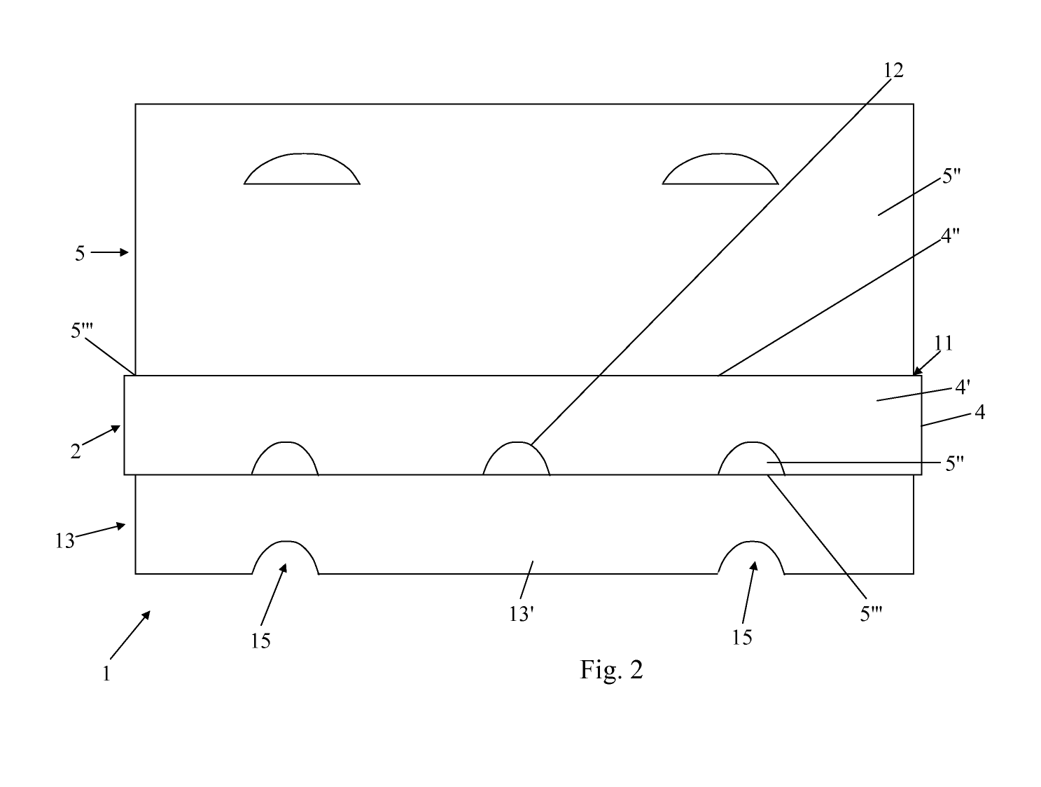

FIG. 2 is a diagrammatic lateral front view of the container that is shown in FIG. 1;

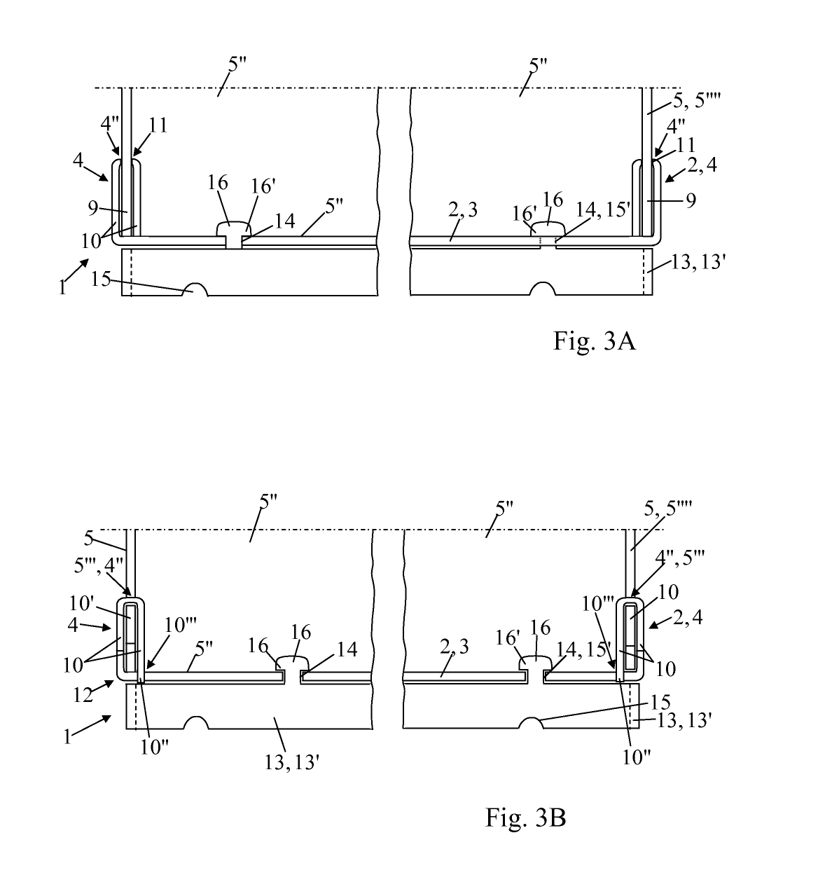

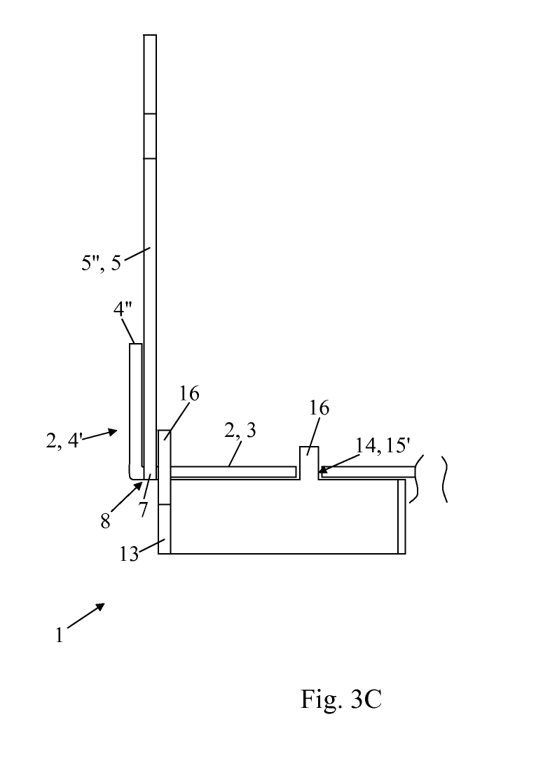

FIGS. 3A, 3B, and 3C are partial cutaway views along A-A, B-B and C-C of the container that is shown in FIG. 1;

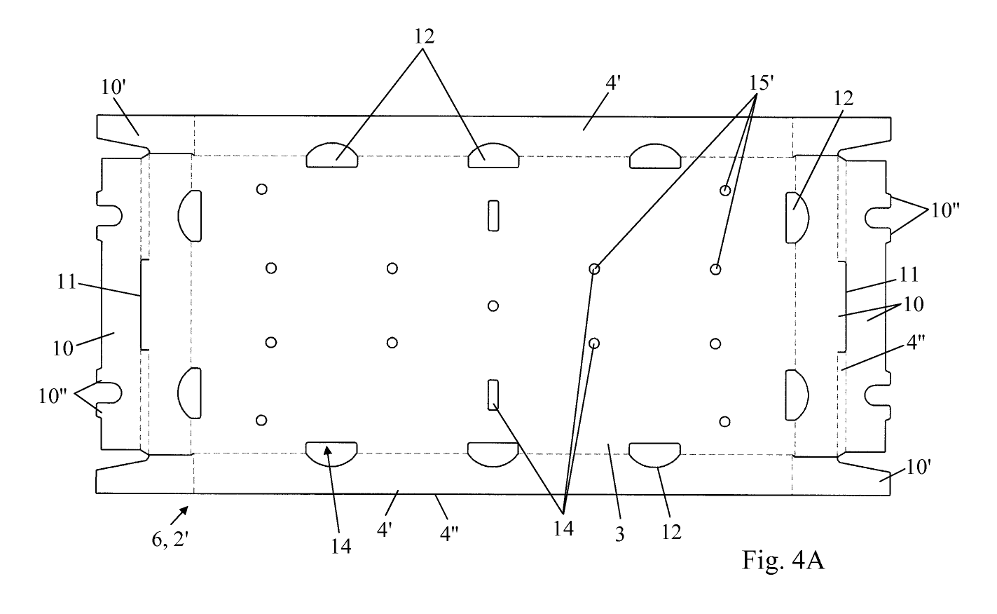

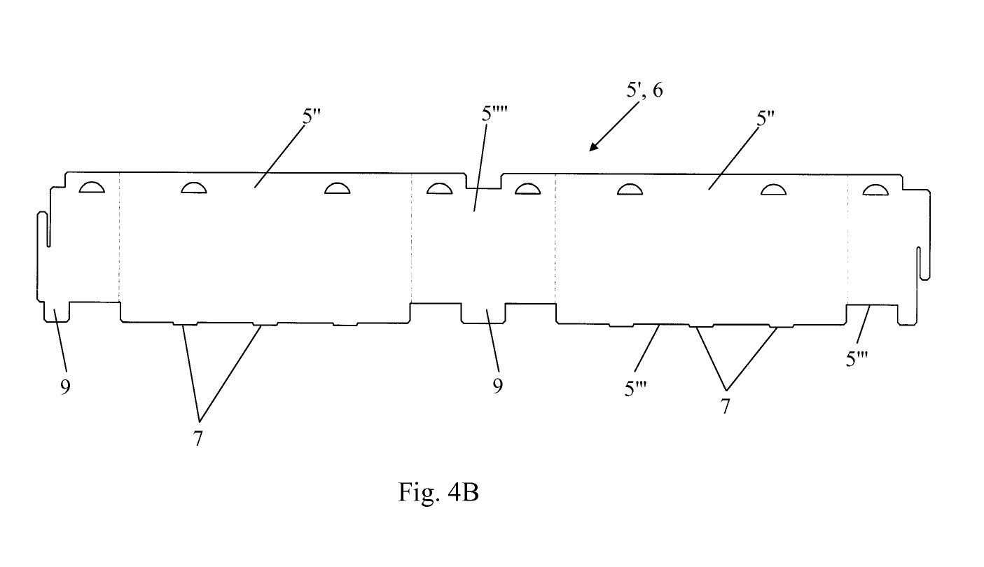

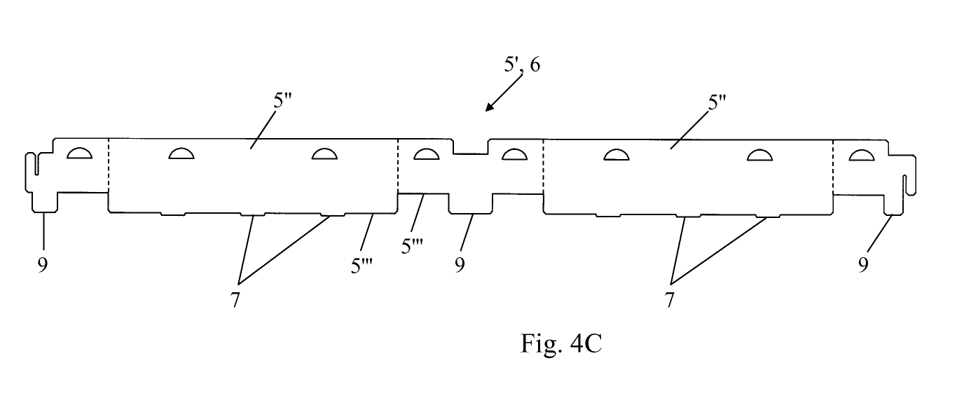

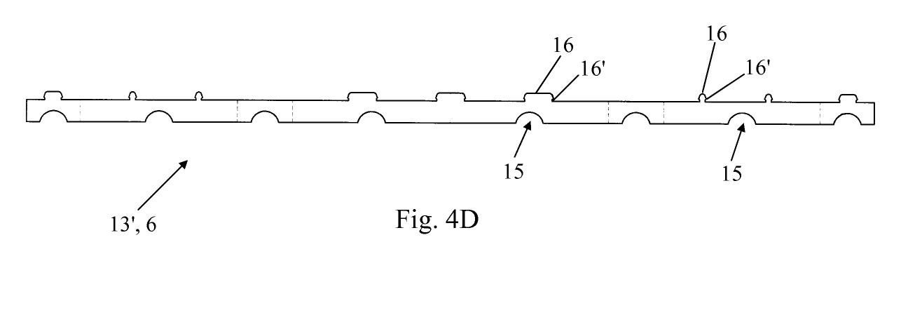

FIGS. 4A, 4B, 4C, and 4D are top views of the sides that respectively form the planter (FIG. 4A), the sleeve-shaped body (FIGS. 4B and 4C), and an underframe structure (FIG. 4D), in the deployed state (the folding lines are indicated in dashes) for a container as FIGS. 1 to 3 show;

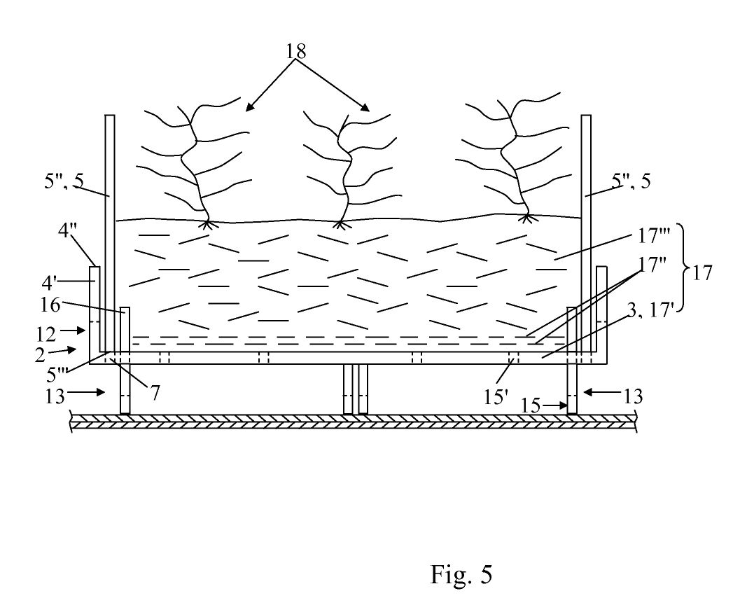

FIG. 5 is a diagrammatic cutaway view (along a cross-sectional plane that is parallel to the width of the container) of a container according to FIGS. 1 to 3, pre-planted and forming part of a system for placing plants, after installation on a substrate (before removal of the upper sleeve);

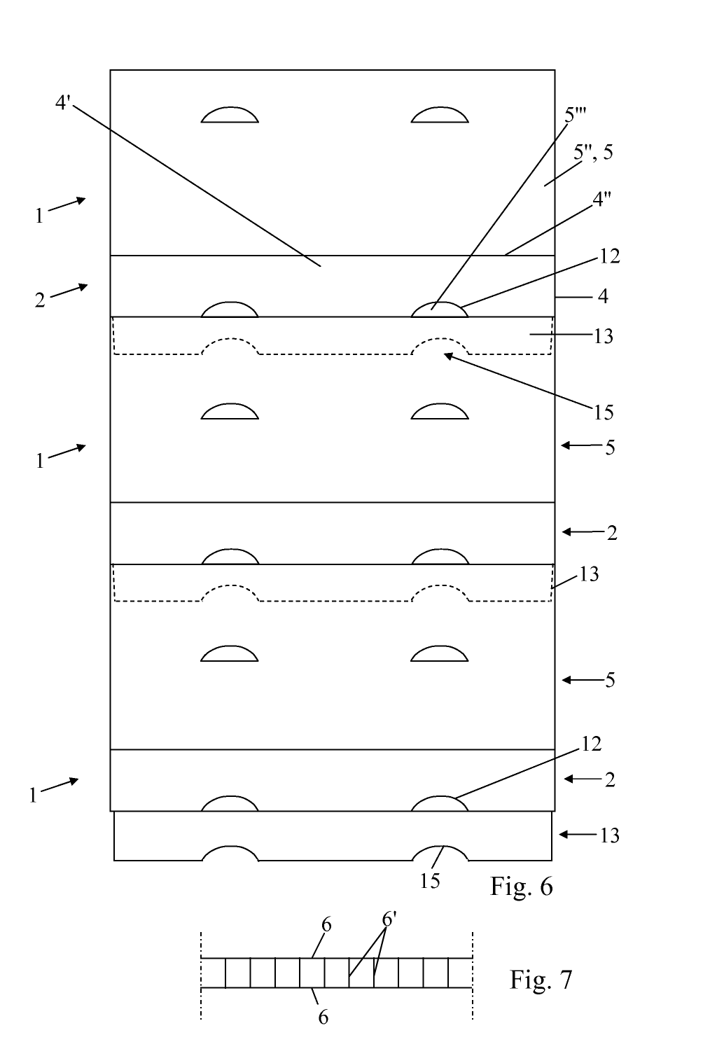

FIG. 6 is a lateral front view of a stack of three pre-planted containers according to FIG. 5, bound together;

FIG. 7 is a detail transversal cutaway view that is on a different scale than the material that constitutes the planter and the sleeve-shaped body that are part of the container according to the invention, as well as optionally the underframe structure;

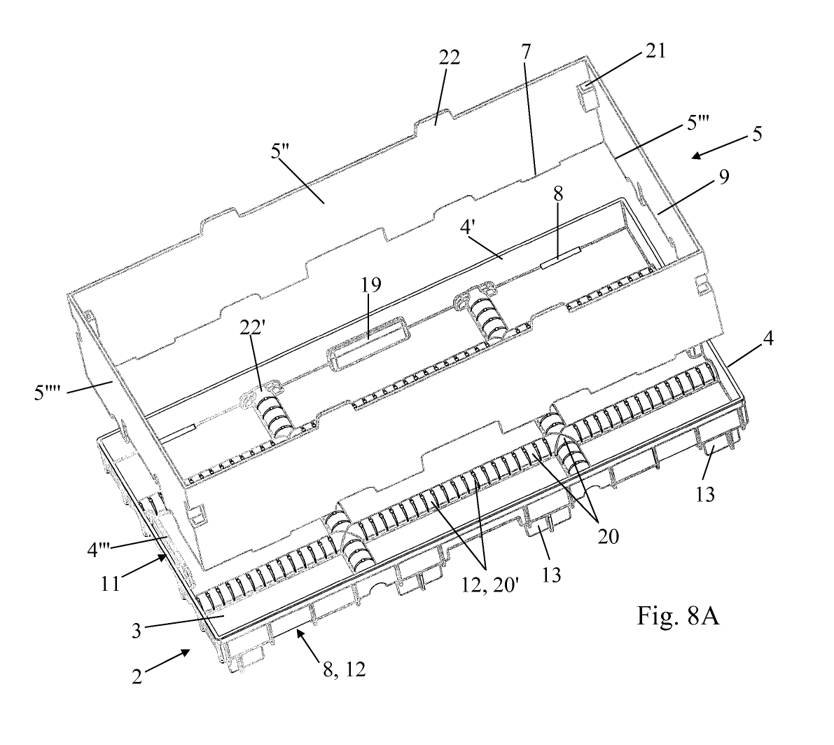

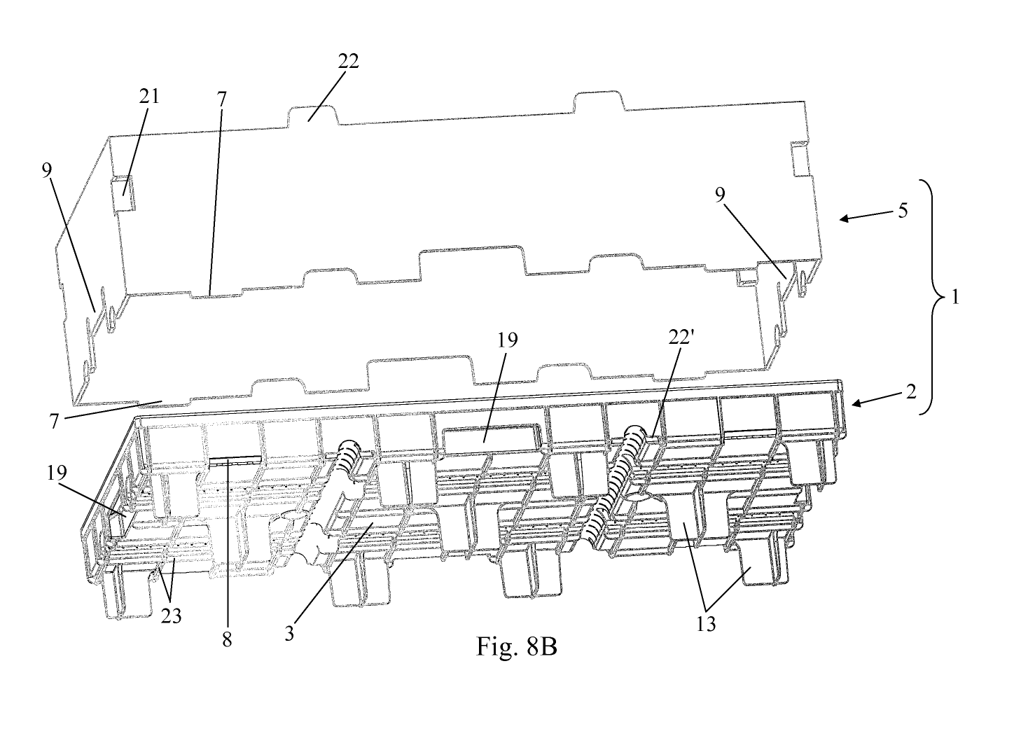

FIGS. 8A and 8B are perspective views in two different orientations of a molded planter and a sleeve-shaped body, forming, after assembly, a container according to a second embodiment of the invention;

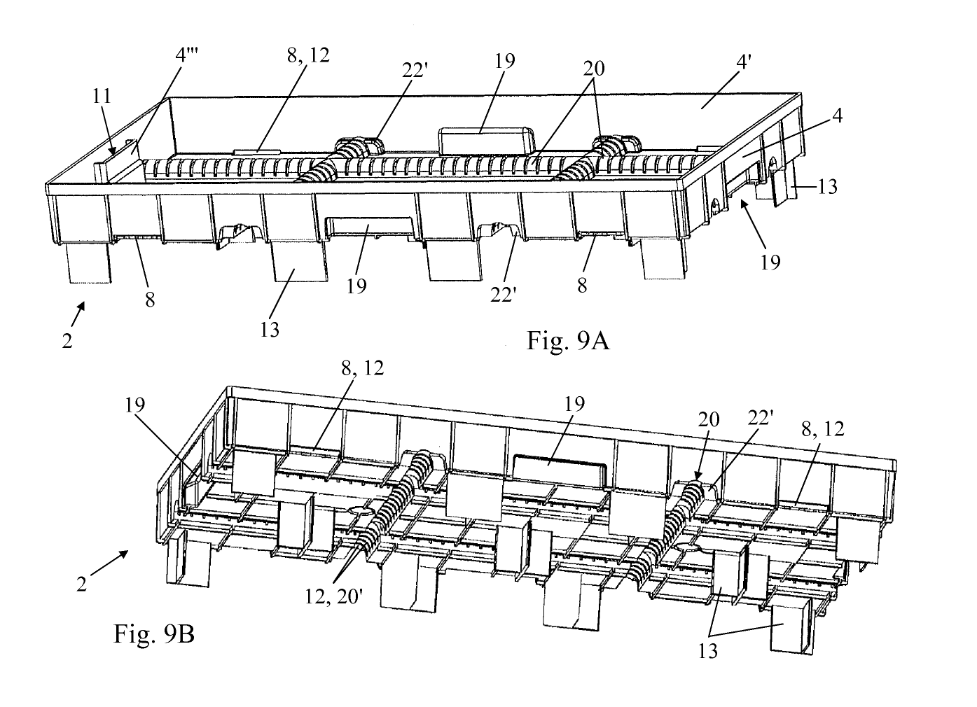

FIGS. 9A and 9B are perspective views of the planter that is part of the container of FIGS. 8A and 8B, in two different directions;

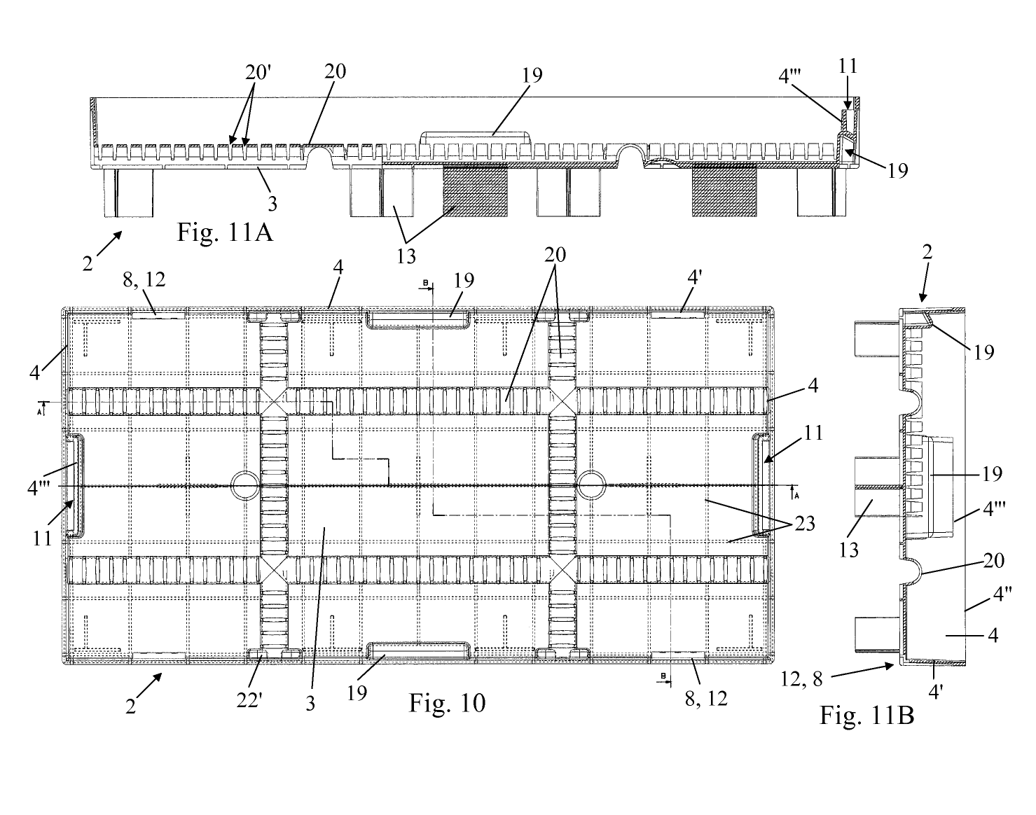

FIG. 10 is a flat front view of the top of the planter of FIGS. 9A and 9B;

FIGS. 11A and 11B are cutaway views along A-A and B-B of the planter that is shown in FIG. 10;

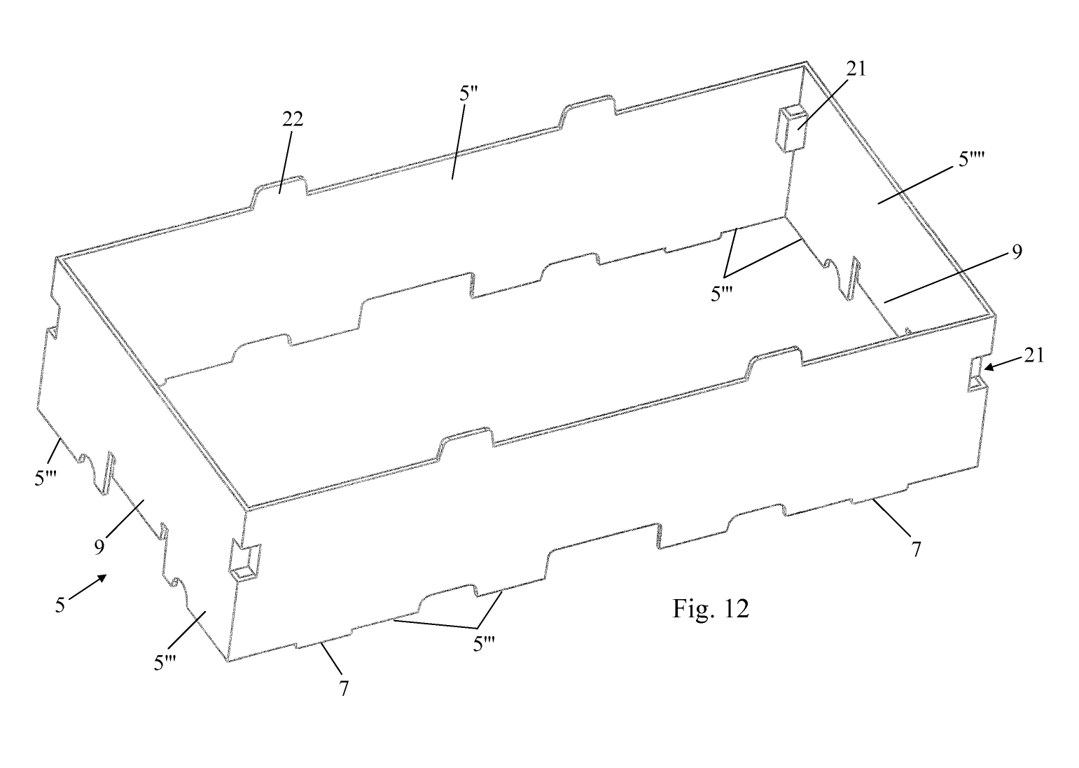

FIG. 12 is a perspective view of a sleeve-shaped body that is part of a container as shown in FIGS. 8A and 8B, and

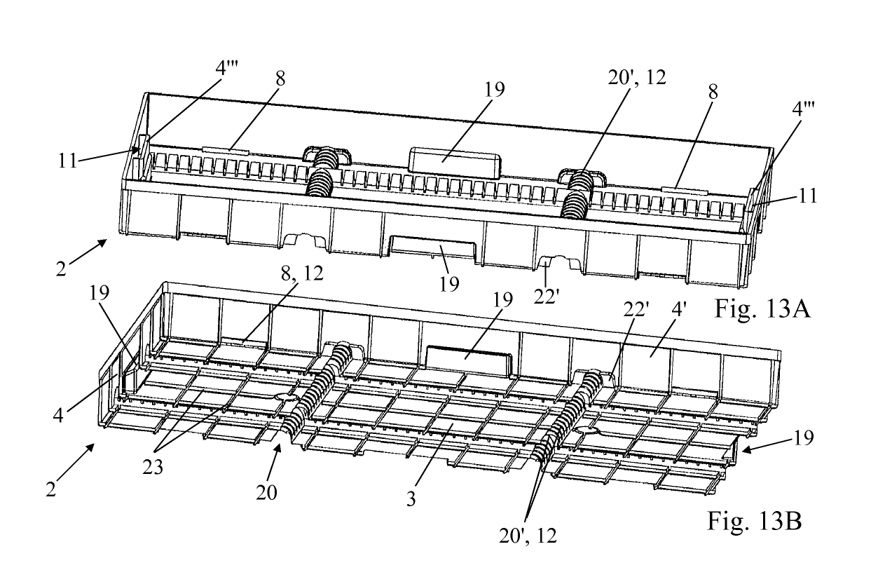

FIGS. 13A and 13B are perspective views in two different directions of a planter according to a variant of the second embodiment of the invention, lacking an underframe.

FIGS. 1 to 3, 5, 6 and 8 show a modular container 1 for planting and cultivation, consisting essentially of a small closed container in the shape of a rectangular planter 2 with a flat or ribbed bottom 3 and side walls 4, 4′ and a rectangular sleeve-shaped body 5 that is mounted in a removable manner on and/or in said planter 2 and extending, in the mounted state, beyond upper edges 4″ of the side walls 4, 4′ of the planter 2.

In accordance with the invention, at least the sleeve 5 is made of a hollow flat material that consists of at least two sheets 6 that are connected by a bridging structure 6′.

The planter 2 can be created in different materials and by means of different manufacturing processes, in particular based on the desired shape, the resistance sought, and/or the constituent material used.

However, according to a first embodiment of the invention, said planter 2 is also made of a hollow flat material that consists of at least two sheets 6 that are connected by a bridging structure 6′ (FIGS. 1 to 3, 5 and 6).

The use of such a material makes it possible to obtain a rigid structure, even with a single wall (a single layer of hollow flat material), for the planter 2 and the sleeve 5, while using a limited quantity of material resulting in a low weight.

In particular, the resistance of the sleeve 5 that is created with this material is thus adequate, on the one hand, to contain the plant complex layer 17 that extends beyond the upper edge 4″ of the side walls 4 and 4′ of the planter 2, and, on the other hand, to support without bending the weight of at least one pre-planted container 1 (complex 17+plants 18), when the latter is bound to a small container 1 that is equipped with such a sleeve 5.

Preferably, the planter 2 and the sleeve 5 of a container 1 each consist of an item that is obtained by folding a respective cut-out side 2′, 5′ of continuous hollow flat material.

Such an embodiment makes it possible to achieve a very low material manufacturing cost, a rigid construction with a flat material of low weight and with a minimum space required for each of the components of the container 1 in the unfolded state, i.e., the planter 2 and the sleeve 5 forming a slatted side.

In accordance with a second embodiment, shown in FIGS. 8, 9, 10, 11 and 13 of the drawings, it may be provided that the planter 2 consists of a planter that is produced by molding, preferably as a continuous finished part.

This second embodiment of the invention makes it possible to obtain a planter with a more rigid structure for the same thickness of walls (side and bottom) and to avoid any manual mounting work for the planter 2, which is carried out from the side (reduction of the costs of labor, manufacturing and automated handling).

The same references have been used below to designate similar parts or elements in the two embodiments.

In accordance with a first variant of the two above-mentioned embodiments of the invention, at least two 5″″ of the walls 5″, 5″″ forming the sleeve 5, preferably at least two walls 5″″ that face the latter, are equipped with at least one tab or anchoring lug 7 at their lower edges 5′″. In addition, the bottom 3 of the planter 2 is equipped with at least two cut-outs 8 in the form of slots, each extending along one of the side walls 4, 4′ of said planter 2 and designed to accommodate said or one of the tabs or anchoring lugs 7, when the wall 5″″ in question of the sleeve 5 rests on said bottom 3, i.e., in the mounted position of the sleeve 5 on and/or in the planter 2.

Thus, in this first variant that is shown partially in FIG. 3C and in FIGS. 8, 9 and 13, the lateral support with locking of the walls 5″, 5″″ of the sleeve 5 is ensured by the side walls 4, 4′ of the planter 2 in cooperation with the anchoring lugs 7 engaged in the slots 8, with the support stresses that may be generated by an upper container 1 supported by the sleeve 5 of a lower container 1 being transmitted directly to the bottom 3 of the planter 2.

In accordance with an additional characteristic or a second variant of the first embodiment of the invention, at least some of the walls 5″, 5″″ that form the sleeve 5, preferably at least two walls 5″ that face the latter, are equipped with at least one tab or anchoring lug 9 at their lower edges 5′″, and at least two side walls 4, 4′ of the planter 2, preferably at least two side walls 4 that face the latter, consist of wings 10 that are folded on themselves, preferably sandwiched with folded wings 10′ that extend the two other side walls 4′ of the planter, and each comprises at least one slot-shaped cut-out 11 at the upper edge 4″ thereof, designed to accommodate said or one of the tabs or anchoring lugs 9 when the wall 5″ in question of the sleeve 5 rests on said edge 4″.

In this second variant of the first embodiment, shown partially in FIGS. 3A and 3B, the lateral support with locking of the walls 5″ in question of the sleeve 5 is ensured by engagement of the tabs or lugs 9 between the two hollow flat material layers of the walls 4, 4′ that consist of the folding of wings 10, with the support stresses that may be generated by an upper container 1 supported by the sleeve 5 of a lower container 1 being transmitted to said double walls 4, 4′ and optionally to the bottom 3 of the planter 2 by the tabs or lugs 9 that rest on the latter.

Clamping the wings 10′ makes it possible to increase the rigidity and the mechanical strength of the planter 2 that is produced by folding in accordance with the first embodiment (connection by overlapping between the walls 4 and 4′/walls 4, 4′ with three hollow flat material layers), while providing the gap that is suitable for the accommodation of tabs or anchoring lugs 9 between the folded wing portions 10 that form the two outside layers of the wall 4 or 4′ being considered.

The folding of the wings 10 is locked by means of the end lugs 10″ that engage in cut-outs 10′″ made in the bottom 3 close to the lateral sides of the latter (see FIG. 3B).

In accordance with an additional characteristic or an advantageous variant of the second embodiment of the invention, at least some of the walls 5″, 5″″ that form the sleeve 5, preferably at least two transverse walls 5″″ that face the latter, are equipped with at least one tab or anchoring lug 9 at their lower edges 5′″. In addition, at least two side walls 4, 4′ of the planter 2, preferably at least two transverse side walls 4 that face the latter, then each comprise at least one slot 11 at their respective upper edge 4″ or close to the latter, in the form of a cut-out or a flat gap between the inside or outside surface of said wall 4 and a wing 4′″ that is formed on the latter and that extends parallel thereto, with each of said slots 11 being designed to accommodate said or one of the tabs or anchoring lugs 9 when the sleeve 5 is mounted in the planter 2 (FIGS. 8A, 9A and 13).

A slot 11 by wall 4, 4′ is normally adequate, taking into account in particular the inherent rigidity of the material that forms the sleeve 5.

Each of the first and second constructive variants described above can affect all of the walls 4 and 4′ of the planter 2.

However, in accordance with a preferred embodiment of the invention, the sleeve 5 has, in the mounted state, at least two opposite side walls 5″ that rest on the bottom 3 of the planter 2 and that are in surface contact with the inside surfaces of the opposite side walls 4′ that correspond to the planter 2, with the other two opposite walls 5″″ of the sleeve 5 optionally resting on the upper edges 4″ of the other opposite side walls 4 of the planter 2, the tabs or anchoring lugs 7 and 11 being engaged in the respective corresponding accommodating cut-outs 8 and 11 of the bottom 3 and side walls 4 in question of the planter 2.

This preferred embodiment consequently applies to each of the structural variants proposed by the first and second above-mentioned variants with a pair of opposite walls 4 or 4′.

In the first embodiment, the sleeve 5 rests, by two opposite walls 5″ (preferably longitudinal—long sides), on the bottom 3 and, by its other two walls 5″″, on the upper edges 4″ of the two opposite walls 4 (preferably transverse—short sides), and in the second embodiment, the four walls 5″ and 5″″ rest on the bottom 3 of the planter 2 (optionally except for tabs 7 and 9 or cut-outs that correspond to retractable projections 19, 21 from the planter 2) or only two 5″ of said walls 5″, 5″″, with the other two 5″″ then resting on the section of, for example, corresponding walls 4 of the planter 2.

Advantageously, in relation to the first embodiment, the side walls of the planter 2—that consist of folded wings 10 of the portion of the side 2′ that constitutes the bottom 3 and that has slot-shaped cut-outs 11 at their upper edges 4″—correspond to the smaller side walls 4 of the rectangular planter 2. In practice, the size ratio between the side walls 4 and 4′ can be two.

So as to allow the evacuation of a possible overflow of water, the bottom 3 and the bases of side walls 4 and 4′ of the planter 2 can be equipped with cut-outs 12 that form through openings, with the cut-outs of bases of side walls 4′ optionally being formed in the extension of the cut-outs in the form of slots 8 of the bottom 3 of the planter 2 that accommodates the—or some of the—anchoring tabs 7 of the sleeve 5.

In accordance with a characteristic of the invention that makes possible the creation of a space for storage, circulation, and controlled evacuation of water under the planter 2, simultaneously bringing the plant complex 17 that is present in the planter 2 out of the water, it may be provided that the container 1 also comprises at least one underframe structure 13 that extends under the planter 2, formed in a single piece with said planter 2 or connected to the latter at attachment sites 14 made in the bottom 3 and having perforations 15 that allow the circulation of liquid under said planter 2.

Preferably, and in connection to the first embodiment, the or each underframe structure 13 can consist of a sleeve or frame that is obtained by folding in a structure that is closed on itself of a strip 13′ of continuous hollow flat material and having, on the one hand, cut-outs 15 that form perforations at its lower edge that is designed to rest on the substrate that accommodates the container 1 and, on the other hand, tabs or assembly lugs 16 that are equipped with bonding means 16′, for example of the hook or shoulder type, and interlocking in the attachment sites 14 made in the bottom 3 of the planter 2 (FIGS. 2, 3 and 4C).

Thus, each underframe structure 13 is made of a material that is similar to the one that forms the planter 2 and the sleeve 5, joining lightness and rigidity.

Preferably, the container 1 can comprise four underframe structures that are aligned two by two under the bottom 3 and formed by aligned pairs from a single strip of hollow flat material 13′ that is arranged edgewise (with its plane located perpendicularly to the plane of the bottom 3).

These underframe structures 13 also constitute stiffening reinforcements of the flat bottom 3 and produce a distributed substrate of the load that is contained in the planter 2.

The material that forms the hollow flat material can be of different natures, in particular bio-sourced or not.

Thus, the hollow flat material can consist of single or double corrugated cardboard, coated by a layer or covered by an airtight wall-facing, also making the hollow flat material resistant to water, at least during the cultivation phase, with the bridging structure 6′ being formed by a corrugated sheet that defines walls connected to two wall-facing sheets 6.

As a variant, the hollow flat material may consist of a section that is extruded from thermoplastic polymer (for example, polypropylene), with the bridging structure 6′ consisting of perpendicular walls that connect the two sheets 6 that form the opposite surfaces of the material.

In relation to the two above-mentioned embodiments, it is preferably provided that the side 5′ that forms the sleeve 5 is cut out and folded in such a way that the bridging walls 6′ extend in the transverse direction relative to the planes of the walls 5″, 5″″ of said sleeve 5.

In relation to the first above-mentioned embodiment, it is preferably provided that the side 2′ that forms the planter 2 is cut out and folded in such a way that the bridging walls 6′ extend in the longitudinal direction for the bottom 3 of the planter 2 and in the transverse direction relative to the respective planes of the side walls 4, 4′ of the planter 2.

According to another variant, and always in relation to the first embodiment, the planter 2, the sleeve-shaped body 5, and, if necessary, the underframe structure(s) 13 are made of hollow flat materials that are different in nature.

According to an additional characteristic of this first embodiment, the flat material that forms the removable upper sleeve-shaped body 5 can have a less rigid structure, and optionally a lower weight, than the flat material that forms the planter 2 and optionally the underframe structure 13.

In relation to the second embodiment of the invention, emerging from FIGS. 8 to 13, it is advantageously provided that the molded planter 2, for example by injection or thermoforming, is made of a thermoplastic polymer material or Thermodur, which may or may not be reinforced by fibrous feedstocks, etc., in particular made of a material that is selected from the group that is formed by polyester, high-density polyethylene and polypropylene.

So as to facilitate the handling of the containers 1, in particular those with a molded planter 2, it may also be provided that at least two opposite side walls 4, 4′ of the planter 2 that is injection-molded or thermoformed, of rectangular shape, preferably the four side walls 4, 4′, have retractable local deformations 19 that define reinforcements on the outside side surfaces of the planter 2, able to be used as handles for gripping the container 1.

So as to stiffen the structure of the molded or thermoformed planter 2 overall, in particular the bottom 3, and to provide simultaneously bidirectional circulation means of the liquid, the wall of the bottom 3 of the planter 2, injection-molded or thermoformed, is advantageously equipped with local deformations 20, preferably with a linear extension in the longitudinal and transverse directions of said planter 2, defining prominent hollow ribs relative to the inside surface of said bottom 3, preferably with a semi-circular cross-section, with these ribs 20 advantageously being equipped with perforations 20′ in the form of transverse slots (FIGS. 8 to 11 and 13).

On the underside of the planter 2, the hollow ribs 20 thus form flow channels for rainwater, and slots 20′ allow drainage of excess water from the planters 2 as well as a passage for the roots of plants that are present in the container 1.

In addition, the bottom 3 can also comprise solid ribs 23 on the outside surface that stiffen said bottom between the hollow ribs 20.

For the purpose of consolidating and stabilizing the binding of containers 1, while distributing more pressure on the rectangular sleeve 5, the latter can be equipped, in the two above-mentioned embodiments, at its corners with retractable projections 21, for example obtained by local deformation by folding cut-out portions of the side 5′ of hollow flat material that constitutes said sleeve 5, with these projections 21 corresponding to support sites for the planter 2 or the underframe 13 of the upper container 1 during binding or stacking of several containers 1 (FIGS. 8A, 8B and 12).

As FIGS. 8 to 13 also show in relation to the second embodiment, the upper edge of at least some of the walls 5′, 5″″ of the sleeve 5 can be equipped with prominent portions 22, for example in the form of tabs, and in that the planter 2 is equipped, at least two opposite side walls 4, 4′, with reinforcements or recesses 22′ of a shape that is essentially complementary to said prominent portions 22, whereby said portions 22 are engaged in the reinforcements or recesses 22′ of the planter 2 of the upper container 1 in the case of stacking with binding of several containers 1.

This arrangement also makes it possible to further stabilize the binding of several containers 1.

These reinforcements or recesses 22′ optionally can be formed in the continuity of ribs 20 at their connection with the side walls 4, 4′ of the planter 2.

As the accompanying drawings show, and based on—in particular—the embodiment of planter 2 according to the invention, the underframe structure 13 can consist of a smaller number of feet with more extended individual support zones (first embodiment) or a larger number of feet with a more limited individual support zone, in particular with a transverse cross-section of X, I, H or T (second embodiment) and formed in a single piece with the molded planter 2.

In the absence of the underframe 13, the planter 2 can be made completely of a putrescible material.

It can be provided in particular that the material that constitutes the planter 2 and/or the material that constitutes the sleeve 5 is/are biodegradable in nature.

In the presence of an underframe structure 13, at least the portion of the side 2′ that forms the bottom 3 in the shape of a plate is made of an imputrescible and resistant material in a sustainable manner with the combined load of the complex and plants, as well as additional loads that may be generated by atmospheric agents (rain, snow, etc.), and even occasional additional loads that are linked to maintenance.

The sides 5′ and, if necessary, the strips 13′ that respectively form the sleeves 5 and optionally the component(s) of the underframe structure 13 are cut out in such a way in the hollow flat material that the result is maximum resistance to the bending in the vertical direction (perpendicular to the bottom 3 of the planter 2), after folding and assembling the container 1.

As FIGS. 4B and 4C show, the sleeves can have varied heights, suitable for the type of plants 18 that are cultivated, for example, and/or the height of the complex layer 17 arranged in the container 1. At their opposite longitudinal ends, the sides 5′ that form the sleeves 5 have bonding lugs that make it possible to lock the fold in a sleeve.

Within the framework of the first embodiment in particular, the bottom 3 of the planter 2 advantageously comprises several openings 15′ for the evacuation of the water, preferably distributed in a homogeneous manner over the entire surface of the bottom 3, with some of these openings 15′ able to be used as an attachment site 14 for the tabs 16 of the component(s) of the underframe structure 13.

By way of example, when the hollow flat material forms the planter 2, the sleeve 5 and the underframe structures 13 consist of an extruded section with a structure as shown in FIG. 7, whereby the side 2′ that constitutes the planter 2 can have a total thickness of approximately 3.5 mm and a weight of approximately 1,000 g/m², the side 5′ that constitutes the sleeve 5 forming a slatted side can have a total thickness of approximately 3.5 mm and a weight of approximately 800 g/m², and the sides 13′ that each constitute an underframe structure 13 can have a total thickness of approximately 5 mm and a weight of approximately 1,050 g/m².

Furthermore, the three constituent components of the container 1, namely the planter 2, the sleeve 5, and the underframe structures 12, optionally can have different colorations, with the planter 2 having a coloration that is close to the one of the plant complex 17 of the upper layer of the latter.

This invention also has as its object, as FIG. 5 of the accompanying drawings partially shows, a system for placing plants on inaccessible surfaces, in particular flat roofs or at least slightly sloped roofs (optionally with significant slopes), whereby said surfaces are water-tight and, if necessary, heat-insulated.

This system is characterized in that it comprises a large number of cultivated modules that are arranged in a mutually adjacent manner on said surface.

In accordance with a first embodiment of this system according to the invention, each module consisting of a planter 2, optionally mounted on at least one underframe structure 13, forming part of a container 1 as described above and filled with a plant complex 17 in which hardy plants 18 that preferably have limited requirements, preferably living plants, are planted, with the height of the plant complex 17 exceeding that of the side walls 4 and 4′ of the planter 2.

As a variant and in accordance with a second embodiment of the invention, each module can consist of a container 1, as described above, at least the sleeve 5 being made of a biodegradable material, as well as optionally the side walls 4, 4′ of the planter 3, whereby each of said containers 1 is filled with a plant complex 17 in which hardy plants 18 that have limited requirements, preferably living plants, are planted.

Finally, the invention also relates to a process for the production of placing plants on flat or sloped roofs, in particular a system for placing plants as described above.

This process is characterized in that it consists in:
Providing containers 1 as described above, each comprising a planter 2, a sleeve-shaped body 5 mounted on this planter 2, and optionally one or more underframe structure(s) 13, and filling said containers 1 to a height of the plant complex 17 that is greater than the width or height of the side walls 4 and 4′ of the planters 2 of the containers 1,
Priming said containers 1 and allowing the resulting plants 18 to grow to a determined degree of development, preferably to a height that is lower than the upper edge of the sleeve-shaped body 5 of the containers 1,
Transporting said planted containers 1 to the site where plants are to be placed by binding them or arranging them in containers with shelves,
Unstacking or extracting the containers 1 on site and placing them side by side, with mutual contact, on the surface to cover, before or after removal or not of the sleeve-shaped bodies 5.

In relation to any of the two embodiments, it can be provided that before they are transported to the site, the pre-planted containers 1 are packaged, for example on palettes, by first creating stacks by binding several containers 1, the planter 2 of an upper container 1 resting on the sleeve-shaped body 5 of the container 1 that is immediately below it.

When the planters 2 are molded, the pre-planted containers 1 can also be arranged, without binding, in shipping containers, by being held laterally at the planters 2.

In particular when the sleeves 5 are not biodegradable, the process can also consist, after installation of the containers 1 on site and removal of the sleeves 5, in recovering the latter for the purpose of their recycling or their reuse, after unfolding and flattening.

The plant complex 17 can be different in nature based on the plants that are planted and can optionally integrate a plant sub-complex, for example in the form of a flexible, water-retaining sheet.

In relation to the example that is shown in FIG. 5, the plant complex 17 can have several superposed layers, namely from bottom to top (from the bottom 3 of the planter 2), a draining layer 17′ that is formed by the perforated bottom of the planter 2, a filtering layer 17″ (for example, a water-retaining felt), and a plant layer 17′″ in which the plants 18 are rooted.

The underframe structure 13 makes it possible to provide a means for temporary water storage (regulation of the purification network) and generally rests on an airtight substrate, for example coated by a bituminous sealing complex.

Of course, the invention is not limited to the embodiment described and shown in the accompanying drawings. Modifications are possible, in particular from the standpoint of the structure of various elements or by substitution of technical equivalents, without thereby exceeding the scope of protection of the invention.

1. Modular container for planting and cultivation, essentially consisting of a rectangular planter with a flat or ribbed bottom and side walls and a body in the shape of a rectangular sleeve that is mounted in a removable manner on and/or in said planter and extending, in the mounted state, beyond the upper edges of the side walls of the planter, a container (1) that is characterized in that at least the sleeve (5) is made of a hollow flat material that consists of at least two sheets (6) that are connected by a bridging structure (6′).

2. Container according to claim 1, wherein the planter (2) is also made of a hollow flat material that consists of at least two sheets (6) that are connected by a bridging structure (6′), with the planter (2) and the sleeve (5) each consisting of an item that is obtained by folding a respective cut-out side (2′, 5′) of continuous hollow flat material.

3. Container according to claim 1, wherein the planter (2) consists of a planter that is produced by molding, preferably as a continuous finished part.

4. Container according to claim 1, wherein at least two of the walls (5″, 5″″) that form the sleeve (5), preferably at least two longitudinal walls (5″) facing the latter, are equipped with at least one tab or anchoring lug (7) at their lower edges (5′″) and wherein the bottom (3) of the planter (2) is equipped with at least two slot-shaped cut-outs (8), each extending along one of the side walls (4, 4′) of said planter (2) and designed to accommodate said or one of the tabs or anchoring lugs (7) when the wall (5″) in question of the sleeve (5) rests on said bottom (3).

5. Container according to claim 1, wherein at least some of the walls (5″, 5″″) that form the sleeve (5), preferably at least two transverse walls (5″″) facing the latter, are equipped with at least one tab or anchoring lug (9) at their lower edges (5′″) and wherein at least two side walls (4, 4′) of the planter (2), preferably at least two transverse side walls (4) that face the latter, consist of wings (10) that are folded on themselves, preferably sandwiching folded wings (10′) that extend the other two side walls (4′) of the planter, and each comprises at least one slot-shaped cut-out (11) at the upper edge (4″) thereof, designed to accommodate said or one of the tabs or anchoring lugs (9) when the wall (5″″) in question of the sleeve (5) rests on said edge (4″).

6. Container according to claim 1, wherein at least some of the walls (5″, 5″″) that form the sleeve (5), preferably at least two transverse walls (5″″) that face the latter, are equipped with at least one tab or anchoring lug (9) at their lower edges (5′″) and wherein at least two side walls (4, 4′) of the planter (2), preferably at least two transverse side walls (4) that face the latter, each comprise at least one slot (11) at their respective upper edge (4″) or, close to the latter, in the form of a cut-out or a flat gap between the inside surface or the outside surface of said wall (4) and a wing (4′″) that is formed on the latter and that extends parallel to it, each of said slots (11) being designed to accommodate said or one of the tabs or anchoring lugs (9) when the sleeve (5) is mounted on and/or in the planter (2).

7. Container according to claim 5, wherein the sleeve (5) has, in the mounted state, at least two opposite side walls (5″) that rest on the bottom (3) of the planter (2) and that are in surface contact with the inside surfaces of the corresponding opposite side walls (4′) of the planter (2), with the other two opposite walls (5″) of the sleeve (5) optionally resting on the upper edges (4″) of the other opposite side walls (4) of the planter (2), the tabs or anchoring lugs (7 and 11) being engaged in the respective corresponding accommodating cut-outs (8 and 11) of the bottom (3) and side walls (4) in question of the planter (2).

8. Container according to claim 5, wherein the side walls of the planter (2) that consist of folded wings (10) of the side portion (2′) constituting the bottom (3) and that have slot-shaped cut-outs (11) at their upper edges (4″) correspond to the smaller side walls (4) of the rectangular planter (2).

9. Container according to claim 1, wherein the bottom (3) and the bases of the side walls (4 and 4′) of the planter (2) are provided with cut-outs (12) forming through openings, with the cut-outs of bases of the side walls (4′) optionally being formed in the extensions of slot-shaped cut-outs (8) of the bottom (3) of the planter (2) that accommodates the or some of the anchoring lugs (7) of the sleeve (5).

10. Container according to claim 1, wherein it also comprises at least one underframe structure (13) that extends under the planter (2), formed in a single piece with said planter (2) or connected to the latter at attachment sites (14) made in the bottom (3) and having perforations (15) that allow the circulation of liquid under said planter (2).

11. Container according to claim 10, wherein the or each underframe structure (13) consists of a sleeve or frame that is obtained by the folding of a structure that is closed on itself of a strip (13′) of continuous hollow flat material and having, on the one hand, cut-outs (15) that form perforations at its lower edge that is designed to rest on the substrate that accommodates the container (1) and, on the other hand, tabs or assembly lugs (16) that are equipped with bonding means (16′), for example of the hook or shoulder type, and interlocking in the attachment sites (14) made in the bottom (3) of the planter (2).

12. Container according to claim 1, wherein the hollow flat material consists of corrugated cardboard, coated by a layer or covered by an airtight wall-facing, with the bridging structure (6′) being formed by a corrugated sheet that defines walls connected to two wall-facing sheets (6).

13. Container according to claim 1, wherein the hollow flat material consists of an extruded section of thermoplastic polymer, with the bridging structure (6′) consisting of perpendicular walls that connect the two sheets (6) that form the opposite surfaces of the material.

14. Container according to claim 12, wherein the side (5′) that forms the sleeve (5) is cut out and folded in such a way that the bridging walls (6′) extend in the transverse direction relative to the planes of the walls (5″, 5″″) of said sleeve (5).

15. Container according to claim 12, wherein the side (2′) that forms the planter (2) is cut-out and folded in such a way that the bridging walls (6′) extend in the longitudinal direction for the bottom (3) of the planter (2) and in the transverse direction relative to the respective planes of the side walls (4, 4′) of the planter (2).

16. Container according to claim 12, wherein the planter (2), the sleeve-shaped body (5), and, if necessary, the underframe structure(s) 13 are made of hollow flat materials of different natures.

17. Container according to claim 16, wherein the flat material that forms the removable upper sleeve-shaped body (5) has a less rigid structure, and optionally a lower weight, than the flat material that forms the planter (2), and optionally the underframe structure (13).

18. Container according to claim 3, wherein the molded planter (2), for example by injection or thermoforming, is made of a thermoplastic polymer material or Thermodur, which may or may not be reinforced by fibrous feedstocks, etc., in particular made of a material that is selected from the group that is formed by polyester, high-density polyethylene, and polypropylene.

19. Container according to claim 3, wherein at least two opposite side walls (4, 4′) of the planter (2) that is injection-molded or thermoformed, of rectangular shape, preferably the four side walls (4, 4′), have retractable local deformations (19) that define reinforcements on the outside side surfaces of the planter (2), being able to use handles for gripping the container (1).

20. Container according to claim 3, wherein the wall of the bottom (3) of the planter (2), injection-molded or thermoformed, is equipped with local deformations (20), preferably with a linear extension in the longitudinal and transverse directions of said planter (2), defining prominent hollow ribs relative to the inside surface of said bottom (3), preferably with a semi-circular cross-section, whereby these ribs (20) are advantageously provided with perforations (20′) in the form of transverse slots.

21. Container according to claim 1, wherein the rectangular sleeve (5) is equipped at its corners with retractable projections (21), obtained, for example, by local deformation by folding cut-out portions of the side (5′) of hollow flat material that constitutes said sleeve (5), whereby these projections (21) correspond to support sites for the planter (2) or the underframe (13) of the upper container (1) during binding or stacking of several containers (1).

22. Container according to claim 1, wherein the upper edge of the sleeve (5) is equipped with prominent portions (22), for example in the form of tabs, and wherein the planter (2) is equipped, at least two opposite side walls (4, 4′), with reinforcements or recesses (22′) of a shape that is essentially complementary to said prominent portions (22), whereby said portions (22) are engaged in the reinforcements or recesses (22′) of the planter (2) of the upper container (1) in the case of stacking with binding of several containers (1).

23. Container according to claim 1, wherein the material that constitutes the planter (2) and/or the material that constitutes the sleeve (5) is/are biodegradable in nature.

24. Process for implementing the placing of plants on flat or sloped roofs, wherein it consists in providing containers (1) according to claim 1, each comprising a planter (2), a sleeve-shaped body (5) that is mounted on this planter (2), and optionally one or more underframe structure(s) (13), in filling said containers (1) to a plant complex height (17) that is greater than the width or height of the side walls (4 and 4′) of the planters (2) of the containers (1), in inoculating said containers (1), and in allowing the resulting plants (18) to grow to a determined degree of development, preferably to a height that is smaller than the upper edge of the sleeve-shaped body (5) of the containers (1), in transporting said planted containers (1) to the site where plants are to be placed by binding them or by arranging them in containers with shelves, in unstacking or in extracting the containers (1) on site, and in placing them side by side, with mutual contact, on the surface to be covered, before or after removal or not of the sleeve-shaped bodies (5).

25. Process according to claim 24, wherein before their transport on site, the pre-planted containers (1) are packaged, for example on palettes, by first producing stacks by binding several containers (1), the planter (2) of an upper container (1) resting on the sleeve-shaped body (5) of the container (1) that is immediately below it.

26. Process according to claim 24, wherein it also consists, after installation of containers (1) on site and removal of the sleeves (5), in recovering the latter for the purpose of their recycling or their reuse, after unfolding and flattening.

27. System for placing plants on inaccessible surfaces, in particular flat roofs or at least slightly sloped roofs, whereby said surfaces are water-tight and, if necessary, heat-insulated, a system wherein it is achieved by means of the process according to claim 24 and wherein it comprises a large number of planted modules arranged in a mutually adjacent manner on said surface, with each module consisting of a planter (2), optionally mounted on at least one underframe structure (3), forming part of a container (13) and filled with a plant complex (17) in which hardy plants (18) that preferably have limited requirements, preferably living plants, are planted, with the height of the plant complex (17) exceeding that of the side walls (4 and 4′) of the planter (2).

28. System for placing plants on inaccessible surfaces, in particular flat roofs or at least slightly sloped roofs, whereby said surfaces are water-tight and, if necessary, heat-insulated, system wherein it is achieved by means of the process according to claim 24 and wherein it comprises a large number of planted modules arranged in a mutually adjacent manner on said surface, with each module consisting of a container (1), at least the sleeve (5) being made of a biodegradable material, as well as optionally the side walls (4, 4′) of the planter (3), each of said containers (1) being filled with a plant complex (17) in which hardy plants (18) that preferably have limited requirements, preferably living plants, are planted.
